(19) United States
(12) Patent Application Publication
(10) Pub. No.: US 2006/0062192 A1
(43) Pub. Date: Mar. 23, 2006

(54) Method for wireless access system supporting multiple frame types

(76) Inventor: William A. Payne III, Glen Ellyn, IL (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/214,536

(22) Filed: Aug. 29, 2005

Related U.S. Application Data
(62) Division of application No. 09/105,826, filed on Jun. 26, 1998, now abandoned.

(51) Int. Cl. H04Q 7/24; H04L 12/54; H04J 3/24; H04L 1/18

(52) U.S. Cl. 370/338; 370/474; 370/428; 714/748

(57) ABSTRACT

A wireless access system having a subscriber subsystem gateway (20) and a wireless router (30) in communication with the gateway via a two-way radio channel (25) according to a communication protocol. The communication protocol has a medium access control (MAC) layer (602, 603, 604, 605) capable of supporting several different network layer frame types (610-612 and 613-615) and includes a MAC layer header (800) having a frame type indicator (801), so that multiple frames of differing frame types are communicated contiguously over the radio channel separated by MAC layer headers.

### FIELD OF THE INVENTION

This invention relates to a wireless access system suitable for broadband wireless access to a residential home or office or business premises, suitable for providing a variety of types of two-way data communication to and from such premises and within such premises.

### BACKGROUND OF THE INVENTION

The pervasive growth of the Internet has been stimulated by the growth in end users wishing connectivity to wide array of services and multimedia content. Most of that connectivity (i.e. access) to the Internet has been through narrowband dial-up lines, with more recent growth in access based on cable modems and high speed digital subscriber line (DSL) technology. To date, wireless access to the Internet has been proposed through wireless modems such as the Motorola Personal Messenger (trade mark) modem giving access to a narrowband wireless system such as ARDIS (trade mark) or cellular digital packet data (CDPD). Such narrowband wireless systems give very slow communications due to the narrow bandwidths available and are also very expensive. Other wireless systems are asymmetric and have the same problems, made worse by limited upstream capacity.

There is a need for a system that provides wireless access to the Internet and Internet Protocol (IP) based services.

IP has certain limitations and other transport protocols are preferred for certain forms of data, Examples are Asynchronous Transmission Mode (ATM) and MPEG (standing for Motion Picture Expert Group). There is a need for a system that is not optimized for a particular transport protocol, but is sufficiently flexible to support multiple protocols over the wireless link.

### SUMMARY OF THE INVENTION

According to a first aspect of the invention, a wireless access system is provided comprising: a subscriber subsystem gateway and a wireless router in communication with the subscriber subsystem gateway via a two-way radio channel and a communication protocol; wherein the communication protocol has a medium access control (MAC) layer capable of supporting a plurality of different frame types and including a MAC layer header having a frame type indicator, whereby multiple frames of differing frame types are communicated contiguously over the radio channel separated by MAC layer headers.

Glossary of Acronyms

ABR—Available Bit Rate
ADSL—Asymmetric Digital Subscriber Line
ASIC—application specific integrated circuit;
DAVIC—Digital Audio Visual Committee
DBS—Digital Broadcast System
DHCP—Dynamic Host Configuration Protocol
FCS—Frame check sequence
FEC—forward error correction
FSK—frequency shift keying
HCS—header check sequence
HDLC—high level data link control
ISDN—integrated services data network
LAN—local area network
MAC—medium access control
MPEG—Moving Pictures Expert Group
NI—network interface
QAM—quaternary amplitude modulation
QPSK—quadrature phase shift keying
PPP—Point to Point Protocol
SNMP—Simple Network Management Protocol
TCP/IP—Transmission Control Protocol/Internet Protocol
UBR—Unspecified Bit Rate
UDP—User Datagram Protocol
USB—Universal Serial Bus
WAN—wide area network

### BRIEF DESCRIPTION OF THE DRAWINGS

FIG. 1 is an overview diagram of the wireless access system in accordance with the preferred embodiment of the invention.

FIG. 2 is a block diagram illustrating the system topology for a wired and wireless in-premises subsystem portion of the system of FIG. 1.

FIG. 3 is a block diagram illustrating the subscriber transceiver of FIG. 2.

FIG. 4 is a block diagram illustrating details of a wireless router of the system of FIG. 1.

FIG. 5 is a frequency spectrum diagram illustrating the wireless chaimel between the in-premises subsystem of FIG. 2 and the wireless router of FIG. 3.

FIG. 6 is a protocol diagram illustrating layers of the communications protocol between the subsystem of FIG. 2 and the wireless router of FIG. 3.

FIG. 7 is a schematic diagram illustrating traffic passing between the subsystem of FIG. 2 and the wireless router of FIG. 3.

FIG. 8 is a frame diagram illustrating the format of a MAC layer header in the protocol of FIG. 5.

FIG. 9 is a frame diagram illustrating a bandwidth request frame.

FIG. 10 is a frame diagram illustrating a frame acknowledgment.

FIG. 11 illustrates a table of frame formats stored at a wireless 30 router and periodically transmitted by the wireless router,

FIG. 12 is an illustration of an allocation map periodically transmitted by a wireless router.

FIG. 13 is a time diagram illustrating an example of linked priority queuing with no fragmentation (not to scale).

FIG. 14 is a time diagram illustrating MAC layer fragmentation and interaction with the physical layer (not to scale).

FIG. 15 is a frame diagram illustrating concatenated frames.

FIG. 16 is a time diagram illustrating transmission on an upstream link,

FIG. 17 is a message flow diagram illustrating exchanges of messages between a residential gateway, a wireless router and a network management module during registration and session initialization,

FIG. 18 is a message flow diagram illustrating exchanges of messages between a residential gateway and a wireless router during a session.

FIG. 19 is a flow diagram of a process implemented at the wireless router. p FIG. 20 is a state diagram illustrating further processes implemented at the wireless router.

### DETAILED DESCRIPTION OF THE PREFERRED EMBODIMENT

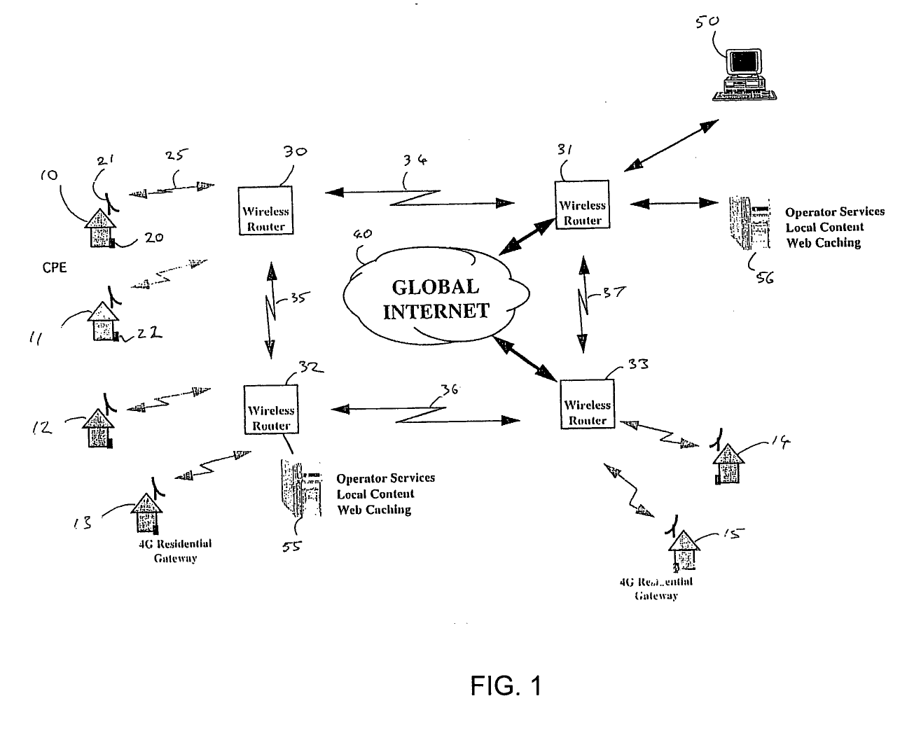

FIG. 1 illustrates a wireless access system in accordance with the preferred embodiment of the invention. It comprises a subscriber subsystem 10, which is preferably an in-premises system in a residential home or small business building. A number of such subsystems 11 to 15 are shown. Each has a subscriber subsystem gateway (eg. gateways and 22). Hereafter subscriber subsystem gateway 20 will be described by way of example and will be referred to as residential gateway 20. The residential gateway 20 is in communication with a roofmounted antenna 21. The antenna 21 communicates over a broad-band radio channel 25 with a wireless router 30. A number of such wireless routers are illustrated, including wireless routers 31, 32, and 33. In the configuration shown, the wireless routers 30 to 33 are in communication with each other over radio links 34, 35, 36, and 37. Some of the wireless routers are connected to a global internet network 40. In the illustrated case, wireless routers 31 and 33 are connected to the global internet network 40.

In alternative (no less preferred) embodiments, each of the wireless routers 30, 31, 32, and 33 is connected directly to the global internet 40. In alternative embodiments, the links 34, 35, 36, and 37 are replaced with land-based links such as a fiber distributed data interface (FDDI) network or 100Base-X links or an asynchronous transmission mode (ATM) network. Other suitable connections are possible, including satellite links. Connected to at least one of the wireless routers (in the illustrated case, wireless router 31) is a node station in the form of a network management module 50. Some (and preferably all) of the wireless routers 30-33 have a content server. Wireless router 32 is illustrated as having content server 55 connected directly thereto. Wireless router 31 is illustrated as having router server 56 coupled thereto.

In operation, a physical link is established between residential gateway 20 and wireless router 30 for transfer of data of various types to and from the subscriber subsystem 10. The establishment of a physical connection over the broad-band radio channel 25 is described in greater detail below and consists, in general terms, of identification by the residential gateway 20 of a pilot channel transmitted by the wireless router 30, identifying to the residential gateway 20 the existence of the wireless router and services or capabilities available from the wireless routers. Using the pilot channel as a guide, the residential gateway 20 transmits a request to the wireless router requesting registration. This request is forwarded by the wireless router over link 34 to network management module 50. Network management module 50 responds to the request for registration and authorizes wireless router 30 to initiate communications with the residential gateway 20 and the subscriber subsystem 10. The manner and extent of communication enabled depends on the level of service to which the subscriber responsible for the subscriber subsystem 10 has subscribed in the network management module 50.

In a similar manner, other subscriber subsystems 11 to 15 establish communication with their local wireless routers. Wireless routers can route communications directly from one subscriber subsystem to another subscriber subsystem served by the same router, or can link those communications over one of the links 34, 35, 36, and 37 to an adjacent or remote wireless router in the system, for onward communication to another subscriber subsystem. Additionally and alternatively one of the wireless routers (e.g. wireless router 31) can route communications from a subscriber subsystem into the global internet network 40.

The content servers 55 and 56 perform operator services and perform caching of web or other content that is either frequently required by subscriber subsystems served by that wireless router, or is likely to be required by a subscriber subsystem or simply caching all suitable traffic that may possibly be required again by a subscriber subsystem.

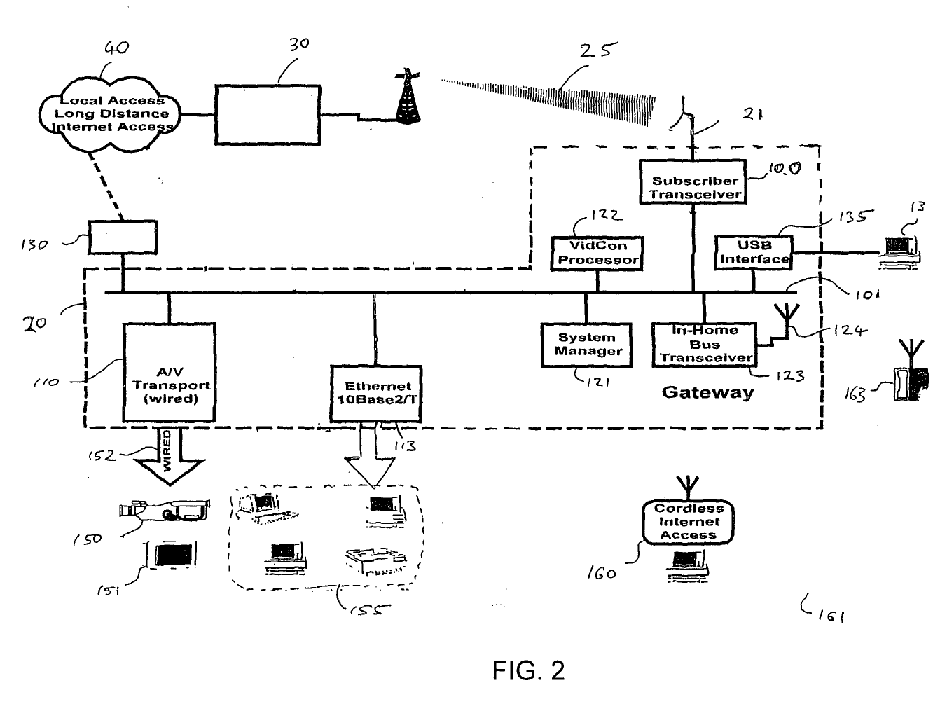

Referring to FIG. 2, details of subscriber subsystem 10 are illustrated. FIG. 2 in particular illustrates a variety of data types that are served by the residential gateway 20. The residential gateway 20 is illustrated in dotted outline and comprises a subscriber transceiver 100 connected to a gateway bus 101. Also connected to the bus 101 are an audio visual (A/V) transport card 110 which is a wired connection and an Ethernet 10BaseT interface 113. Also connected to the bus are a system manager 121, a video processor 122, a USB interface 135 and an in-home bus transceiver 123, coupled to an in-premises antenna 124. The USB interface 135 is coupled to a computer 137. Other interfaces 130 can be coupled to the bus, connecting the gateway 20 to the global internet network 40, or to other local access or long distance services, such as an ADSL interface, a POTS interface, an ISDN interface, a DBS interface, and a cable modem (none of these is shown). A POTS emulation card can be connected to the bus 101 in the home, to connect to a telephone terminal (not shown).

In terms of appliances and other devices in the home or building that are served by the gateway 20, the A/V transport card 110 serves one or more video cameras 150 and one or more monitors 151 coupled over a wired connection 152. The Ethernet 10BaseT interface 113 can serve various computer terminals, servers, printers and other such devices 155. The in-home bus transceiver 123 is coupled by its antenna 124 to various cordless devices such as a cordless internet access 160, and a cordless telephone 163.

FIG. 2 illustrates what can be described as a fully functional and complex system. A minimum system would, for example, have just the transceiver 100 coupled to the bus 101 and the system manager 121 and one of the elements 110, 11.3, and 1.23, typically the Ethernet 10BaseT 113 and its associated devices 155. Nevertheless, a generalized system is described that is capable of supporting multiple data types such as compressed MPEG video, internet protocol data and asynchronous transmission mode (ATM) cells. This system is capable of supporting all these data types even if only one of these data types is used in any given subscriber subsystem configuration.

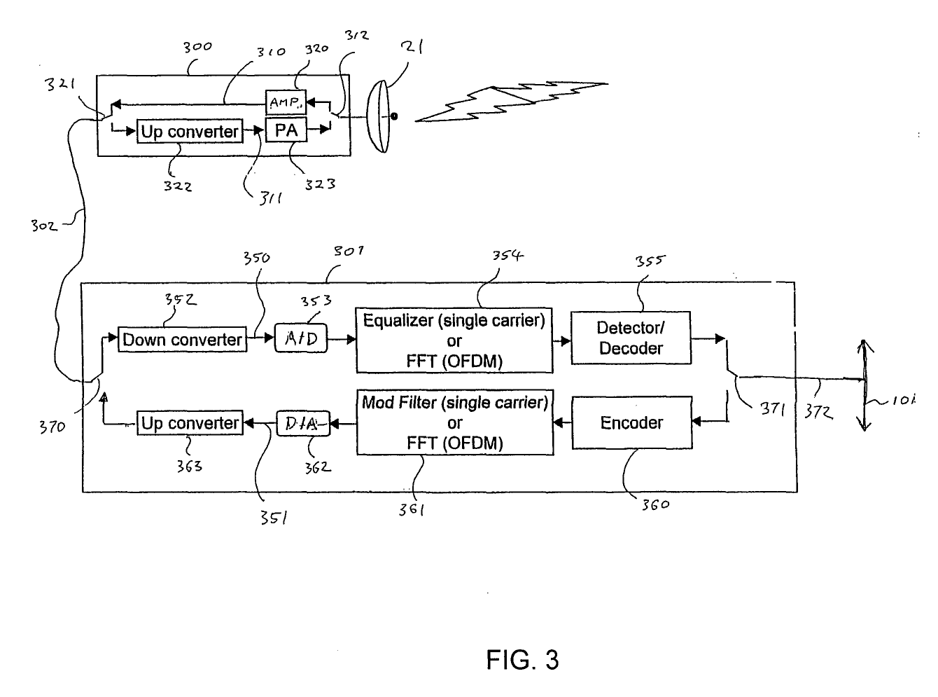

FIG. 3 shows in greater detail the subscriber transceiver 100 of FIG, 2. In the preferred embodiment, the subscriber transceiver 100 comprises an outdoor part 300 and an indoor part 301, connected by a cable 302. The outdoor part 300 is mounted with the antenna 21 (which is illustrated as being a dish antenna pointed towards the wireless router). The outdoor part 300 comprises a receiver path 310 and a transmitter path 311, An antenna switch 312 couples the antenna 21 selectively to one of the receiver path 310 and the transmitter path 311. When coupled to the receiver path, the antenna switch 312 couples the antenna 21 to a low noise amplifier 320 and through the low noise amplifier to a cable switch 321. The cable switch is a 2-way cable switch and, when switched to the transmitter path 311, it connects the cable 302 to an up converter 322, which in turn is connected to a power amplifier 323 and, via the antenna switch 312. The power amplifier 323 is connected to the antenna 21. The switches 321 and 312 switch in unison between the transmitter path and the receiver path.

The indoor equipment 301 also comprises a receiver path 350 30 and a transmitter path 351. In the receiver path, there is a downconverter 352 coupled to an analog to digital converter 353, coupled in turn to an equalizer or fast Fourier transform circuit 354, which in turn is coupled to a detector/decoder 355. In the transmitter path there is an encoder 360 connected to a modulator filter or fast Fourier transform circuit 361, connected in turn to a digital to analog converter 362, which is connected to an up converter 363. The 2-way cable switch 370 connects the cable 302 selectively between the receiver path 350 and the transmitter path 351. A 2-way data switch 371 connects one of the detector/decoder 355 and the encoder 360 to the residential gateway bus 101 via connection 372.

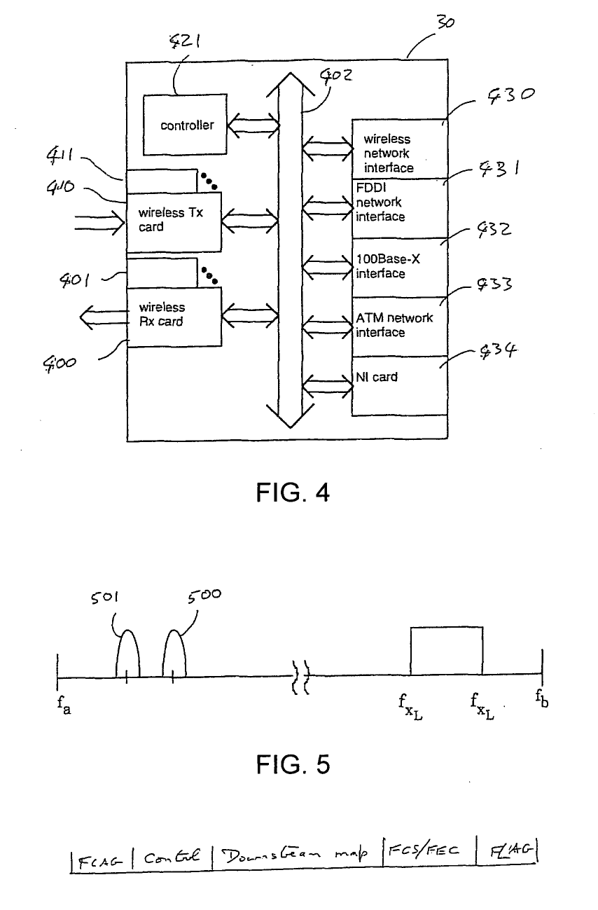

Referring now to FIG. 4, the description of the system hardware continues with an illustration of the wireless router 30. The wireless router 30 comprises multiple wireless receiver cards 400, 401, etc. and multiple wireless transmitter cards 410, 41.1, etc. There is one transmitter card and one receiver card for each radio band connecting the wireless router 30 with the subscriber subsystems that it serves. Suitable radio bands are in the 2.5 GHz radio band, the 5 GHz radio band and the 28 GHz radio band. It is not necessary for the wireless router 30 to serve multiple radio bands. Any one of these radio bands will suffice for the system. Accordingly, at a minimum there is just one wireless transmitter card and one wireless receiver card.

The transmitter and receiver cards 400, 401, 410 and 411 are connected to a wireless router bus 420. Also connected to the bus are a controller and one or more interface cards for linking the wireless router to other wireless routers or to the global internet or other networks. These interface cards include a wireless network interface 430, a FDDI network interface 431, a 100Base-X interface 432, an ATM network interface 433, and another network. interface card 434.

The network interface cards 430-434 performs the tasks of ATM layer segmentation and reassembly (BAR), and forwarding, or layer 3 routing and forwarding, with or without bridging. Packets or frames are transmitted to the appropriate network after these functions are performed.

Each of the cards 400 or 410 or 421 or 430 to 434 has a processor or controller (e.g. a microprocessor or an ASIC), having loaded therein software that performs certain functions as follows. The controller 421 performs routing protocols, signaling functions, MAC protocol scheduling and spectrum management and it includes SNMP agents. The wireless transmitter cards 410 and 411 perform MAC protocol formatting and processing and performs spectrum management. The wireless receiver cards 300 and 301 perform MAC protocol formatting and processing, spectrum management, IP, MPEG. and/or ATM forwarding. The wireless network interface 430 performs MPEG forwarding and spectrum management from the link 34. The FDDI network interface 431 performs IP forwarding, as does the 100BaseT interface 432. The ATM network interface 433 performs IP forwarding, ATM forwarding and MPEG forwarding.

In operation, different types of data need to be transferred between the various interface cards of the wireless router 30 and the various in-home devices illustrated in FIG. 2. For example, internet protocol (IF) need to be transferred between the computer devices 155 in the subscriber subsystem and either the wireless network interface card 430 or the FDDI network interface 431 or the 100Base-X interface 432. At the same time, MPEG or other compressed video needs to be transferred between the audio visual transport card 110 or the video processor 122 of the subscriber subsystem and either the wireless network interface card 430 or the ATM network interface card 433. Simultaneously, ATM cells may need to be transferred between the ATM network interface card 433 and one of the other interface cards in the gateway, for example the USB interface 135 or the in-home bus transceiver 123.

All these data types (and other data types either existing or not yet devised) need to be supported simultaneously, but with differing requirements, for example, differing quality of service (QoS) requirements. For example, it may be important for real-time video to be transferred through the system with low delay variation so as to result in minimum jitter of video images. Similarly, it is desirable for telephone voice traffic to be transferred through the system with minimum delay so that telephone conversations are not disrupted by excessive delays in the 2-way connection. On the other hand, Ethernet and IP data packets can generally tolerate longer delays in end-end transfers. The challenge is to support all these high bandwidth, high data rate packet types on a common radio channel, which inherently has limited bandwidth, for example, typically less bandwidth than an optical fiber or coaxial cable.

To support these multiple data types, a novel protocol is devised and managed between the residential gateway 20 and the wireless router 30. The novel protocol strives to flexibly allow a multiplicity of subscriber devices to statistically share paths to the network management module 50 and the global internet 40.

As a first element of the protocol, there is an initialization between the residential gateway 20 and the network management module 50. To facilitate initialization, there is a pilot channel on the radio channel 25. This is illustrated in FIG. 5. Considering the entire bandwidth available for the radio channel 25, stretching from fₐ to f_{b} there is a downstream pilot channel 500 broadcast by the wireless router 30 to any subscriber subsystem wishing to initialize. There is an upstream pilot channel 501 available for any subscriber subsystem to commence initialization. These channels are illustrated at the lower end of the available radio bandwidth. The available bandwidth may, for example, be in the range 5.05.1 GHz, but other bandwidths at 14 GHz or 18 GHz could equally suffice.

All wireless routers 30, 31, 32 and 33 use the same frequencies for the upstream and the downstream pilot channels 501 and 500. Similarly, the modulation (at least on the downstream) is common to all wireless routers, The modulation can be QPSK, FSK or QAM (e.g. 64 QAM). The downstream framing for the pilot channel is the same for all wireless routers and is preferably synchronous, based on HDLC and/or DAVIC specified framing.

A new subscriber unit or residential gateway that is not previously registered with the network management module 50 goes to the known downstream broadcast pilot channel upon power up. This downstream pilot channel periodically broadcasts a spectrum description map of all the channels/carriers available in the entire spectrum from fₐ to f_{b}, as well as parameters associated with those channels, including cutoff frequencies, modulation, upstream or downstream channel, associations between upstream and downstream channels, etc. The downstream frame format comprises a flag, followed by a number of controlled bits, followed by the downstream spectrum description map, followed by FCS or FEC coding and finally a flag, after which the frame repeats. There may be varying degrees of error detection and correction based on service needs across the component channels. There should at least be protection for the frame header, using a check sequence.

On a periodic basis the network management module 50 sends a message through wireless router! 31 and through wireless router 30 to subscriber subsystems served by the wireless router 30 (and indeed to all subscriber subsystems served by all wireless routers) inviting new unregistered subscriber devices to register themselves with the system. This request is sent on the downstream pilot channel 500. A new subscriber device receiving this invitation can match itself up with the channel rate and modulation described in the downstream spectrum description map. Alternatively, it can choose to try to introduce a new channel into the spectrum, specifying its own parameters for the new channel!! The message from the subscriber device to the wireless router 30 is over a shared upstream channel 501.

There is the possibility of collisions in responses from devices requesting registration. The system does not support carrier sensing and a link layer provides for confirmation as to whether or not a MAC layer registration request was delivered from the gateway to the wireless router 30. Upon receipt of a request by the wireless router 30 (or at the upstream node), an acknowledgment of that request is returned by the node station or the network management module, If a device requesting registration does not receive an acknowledgment before it receives a new registration request message from the node station, then it assumes that its message was lost due to contention. Under these circumstances, a back-off algorithm is initiated and, following next receipt of an invitation to register, the subscriber device delays by a back-off delay time before sending a new request for registration. The back-off delay time is either random, or is determined by some deterministic scheme (e.g. related to device identification number), such that responses to a registration invitation are distributed in time in the time following the registration invitation. As a result, any two colliding responses are less likely to collide upon the second attempt or subsequent attempts.

Upon receipt by a wireless router 30 of an acknowledgment from network management module 50, the wireless router transmits to the requesting subscriber device a set of channel parameters defining a channel that is being allocated to that subscriber device. The set of channel parameters is transmitted in the downstream pilot channel. The channel parameters transmitted to the requesting subscriber device include the frequency range for the channel allocated, for example, F_{xL} to F_{xL} as shown in FIG. 5, and define the modulation scheme and the data type being supported.

The frequencies F_{xL} to F_{xL} preferably define a channel within the total available bandwidth such that several similar channels can coexist in a frequency division multiplex manner. A suitable channel width is 20 MHz in the 5.0-5.1 GHz range—i.e. each channel consuming approx. one fifth of the available bandwidth and allowing up to five such channels to be set tip side-by-side. Of course these figures are approximate as a small amount of bandwidth must be set aside for the pilot channels 500 and 501 and for guard bands between channels. FIG. 5 is not to scale.

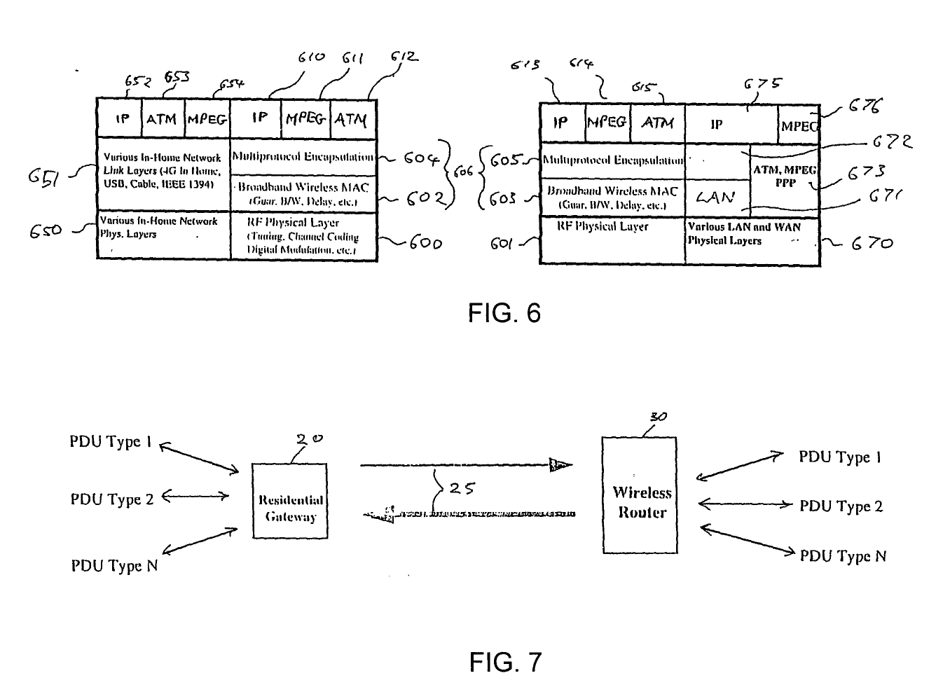

The above described initialization procedures are controlled and operated by software located in the system manager 121 of the residential gateway 20 and the controller 321 of the wireless router 30, as well as software located in the network management module 50. 25. In this manner, a channel is established between the residential gateway 20 and the wireless router 30. The channel has a protocol as illustrated in FIG. 6. The channel protocol has a physical layer 600 at the residential gateway 20 and a corresponding physical layer 601 at the wireless router 30, which exactly matches the physical layer 600 at the residential gateway and which is defined by the channel parameters described above. Above the physical layer 600 is a medium access control (MAC) sub-layer 602 (at the residential gateway side) and 603 (at the wireless router side), which is described in greater detail below. A wireless data link layer 606 includes a multi-protocol encapsulation sub-layer 604 and 605. Above the multi-protocol encapsulation sub-layer 604, 605, are the various network layer protocols that are supported by the channel, including Internet Protocol (IP) 610, MPEG 611 and ATM 612 (and corresponding protocols on the wireless router side 613, 614 and 615). A transport layer (not shown) is provided above the network layer. Examples of a suitable transport layer are TCP and UDP.

Sub-layers 604 and 602 together form a data link layer. Sub-layers 605 and 603 are also elements of the data link, layer.

FIG. 6 also illustrates protocols on the in-home side of the gateway 20 and the network. side of the wireless router 30. Thus, in- home network physical layers 650 are represented, which include the in-home bus transceiver 123, the cable television interface 130, the 10BaseT (113), IEEE 1394 (Firewire), and the USB interface 135. These physical layers are physically connected to the residential gateway physical layer 600 via the bus 101. Above the various in-home network physical layers 650 are various in-home network link layers 651 and above these are the respective data protocols supported by the system, including IP 652, ATM 653 and MPEG 654. The IP layer 652 supports worldwide web image and file transfer, IP voice, internet-based digital video and video conferencing. The MPEG protocol 654 supports digital video, near video-on-demand and video-on-demand. Additional network protocols can coexist with the IP, ATM and MPEG protocols, and may be known or not yet developed protocols.

On the network side of the wireless router, FIG. 6 shows various LAN and WAN physical layers 670 (these being the various network interface cards 330 to 334). These physical layers are connected to the RE physical layer 601 via the bus 302. Above the various physical layers 670 are LAN sub-layers 671 and 672, as defined by IEEE 802.3 and 802.2, respectively. Additionally, and indeed alternatively, there are ATM, MPEG or PPP layers 673, these being generally considered as being wide area network protocols. Above these various layers are an IP protocol layer 675 supporting worldwide web image/file transfer, IP voice, internet based digital video and video conferencing. Above layer 673 supporting MPEG is a MPEG layer 676, supporting digital video, near video-on-demand and video-on-demand.

Referring now to FIG. 7, a schematic illustration is given showing how various packet data units of N different types are multiplexed and de-multiplexed between the residential gateway 20 and the wireless router 30. Packet data units (PDUs) of type 1, type 20 and type N are fed into the residential gateway 20 and multiplexed onto the radio channel 25, received at the wireless router 30 and demultiplexed at the wireless router 30 into PDU's of type 1, type 2 and type N. Similarly, PDU's are received at the wireless router in N different types, are multiplexed onto the radio channel 25, received at the residential gateway 20 and de-multiplexed into PDU's of type 1, type 2 and type N. Different PDU's are distinguished in type by either: (a) being of different fixed lengths, eg. ATM cells and MPEG-2 transport packets, which are examples of fixed length packets; or (b) being of fixed and variable length, for example, ATM cells and Ethernet MAC frames, where ATM cells are fixed in length and Ethernet MAC frames are variable in length. The arrangement described supports packet data unit types of differing fixed lengths, as well as packet data units of fixed length side-by-side with packet data units of variable length.

Each downstream channel has associated with it one or more upstream channels to the network, Symmetric and asymmetric connectivity is supported, where the symmetry or asymmetry of the channels is indicated in the response to the connection request during initialization.

Different types of frames are multiplexed on the downstream in a time divided manner. The frame type is indicated in a header in the encapsulation sub-layer 604, 605 of the protocol. Each frame type has a number of bytes associated with that frame type or (in the case of a variable length frame type) a maximum size. A table of these frame types is sent periodically on the downstream channel (including the initialization channel) from the wireless router 30 to the residential gateways 20, 22 etc.

Time division multiple access is used on the upstream path. A subscriber device requests to transmit a number of frames (and frame types) to the node station. The node station (either wireless router 30 or an upstream node) processes the request and acknowledges and either grants or denies the request on the associated downstream channel. When a request for a channel is granted by the wireless router 30, the controller 321 of the wireless router 30 adds an indication of the newly granted channel in a channel allocation map that it periodically transmits downstream (i.e. to the residential gateways). The map describes the allocation of bandwidth over time and describes grants for subscriber units to transmit upstream. The subscriber device (e.g. the residential gateway) receives and stores this channel allocation map in memory associated with its system manager 121 and the system manager 121 controls start and end times of transmission of the transceiver 100 according to allocated times in the channel allocation map.

An upstream request can occur either on the upstream data channel as an individual message, or on a separate request channel upstream or by piggybacking the request onto a frame that is already in transit upstream.

Hosts that are active on the upstream channel are expected to stay synchronized on the upstream path by observing the downstream allocation maps and by updating their byte count (local) to coincide with the frames being delivered upstream. The byte count is maintained in a counter in the gateway system manager 121 (FIG. 2). The periodic byte count also helps in a fading environment since it provides a mechanism for the gateway device to quickly update its local byte count.

For further illustration, there is now described a frame format including frame level encapsulation. The frame level encapsulation in the multiple encapsulation sub-layer 604 consists of a header of 7 bytes, in addition to the payload being encapsulated and delivered from the layer above (either the IP layer 610 or the MPEG layer 611 or the ATM layer 612).

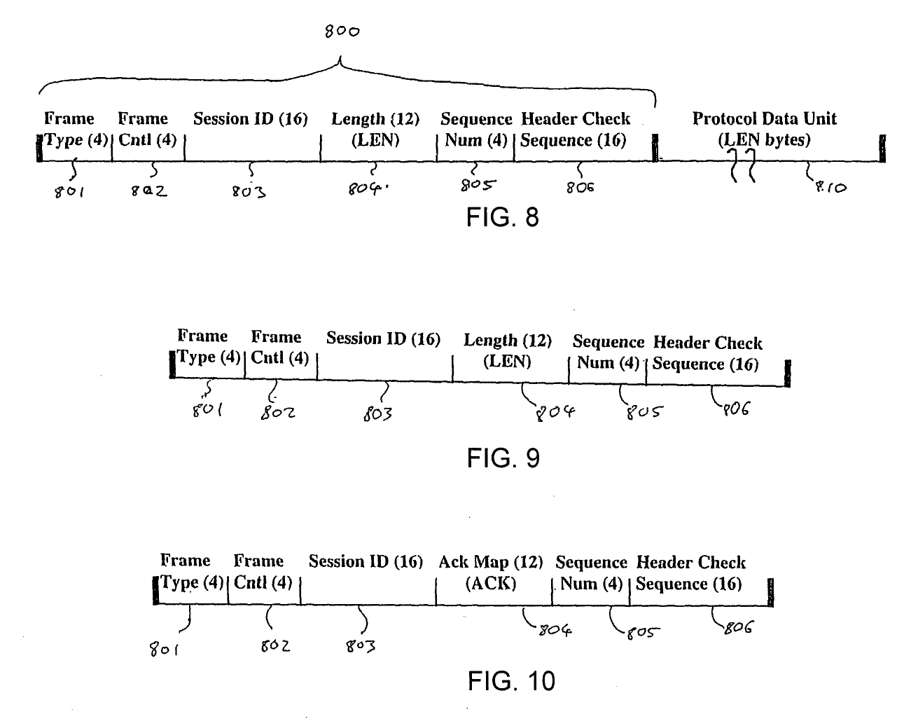

As shown in FIG. 8, the frame format comprises a 7-byte header 800 (each byte being 8 bits). The frame header comprises a 4-bit frame type field 801, a 4-bit frame control field 802, a 16-bit session ID 803, a 12-bit length indicator field 804, a 4-bit sequence number 805 and a 16-bit header check sequence 806. Following the header 800 is the protocol data unit 810, which is fixed in length if the PDU is an ATM cell or an MPEG packet but is variable in length if the PDU is an internet protocol frame.

The frame type field 801 can indicate any one of sixteen frame types selected from three categories: different types of network layer frame (e.g. ATM/MPEG/IP); different types of MAC layer operational frames (e.g. request/ack/grant); and one management frame. More specifically, the following frame types are described: Ethernet frame, MPEG-2 video packets, ATM, MAC fragment, bandwidth request, frame acknowledgment, management and reserved types. The frame control field 802 can indicate supplementary frame type information the definition of which is dependent on the type of frame. The session ID field 803 indicates a residential -gateway ID along with an associated virtual connections. There may be multiple session ID's that are active between the residential gateway and the wireless router corresponding to multiple existent sessions. Session ID's are assigned at the start of the session and deallocated at the termination of a session. The session ID is unique within the operator's autonomous network, allowing for nomadicity and future mobility. Special IDs can be used to identify multicast or broadcast sessions. The length field 804 is the length, in bytes, of the PDU that follows and has a maximum of 4096 bytes. The sequence number is a MAC frame sequence number, counted in modulo 16. The header check sequence field 806 insures proper delivery of the PDU, but does not indicate the integrity of the PDU.

Error checking could also be performed over the PDU itself if the service warrants it. As mentioned above, one of the frame types indicated in field 801 is a bandwidth request frame. This is a frame that passes in the upstream direction only, from the residential gateway 20 to the wireless router 30. This frame is illustrated in FIG. 9. It comprises the same fields as the header 800 of FIG. 8, but without any PDU 810. In this instance, the frame type indicated in field 801 indicates a bandwidth request. The frame control field 802 indicates the frame type being requested. The session ID field 803 indicates the logical connection/session associated with a particular residential gateway, a host terminal or residential gateway ID, along with an associated quality of service and connections. The length field 804 now indicates the number of bytes or frames being requested (instead of the length of the PDU), The sequence number field 805 indicates the MAC frame sequence number. As before, the header check sequence 806 insures proper delivery of the frame.

Note that the upstream bandwidth request message is the only message for which there can be contention on the upstream channel. It is therefore advantageous that this request be a very small packet. This minimizes the possibilities of collisions. Collisions are detected by the reception of an invalid HCS. The bandwidth request frame applies for cases where the upstream band is demand assigned for a session/connection with no bandwidth guarantees or one for which bandwidth has been reserved. In either case, a residential gateway must request to send a packet on the upstream channel. The wireless router will schedule it based on the bandwidth that has been reserved (or lack thereof). In these cases the length field 804 is redefined to indicate the number of units of type indicated by frame that are queued ready for transmission to the wireless router 30. In the case of an internet connection, the length field 804 indicates number of bytes of a single frame.

A further frame type is a frame acknowledgment. This has the same structure as illustrated in FIG. 10. The frame type field 801 contains a frame acknowledgment type indicator. The frame control field 802 is unused. The session ID field 803 indicates residential gateway ID along with associated connections, as before. The field 804 which was previously a length field is now used as an acknowledgment field. The 12 bits of this field are used as an acknowledgment map, for acknowledging (or negatively acknowledging) up to 12 previous frames. A zero in any bit position indicates a missing frame. A missing frame is identified by the failure to receive a frame having a sequence number that lies consecutively between two successfully received frames. The sequence number field 805 contains a MAC frame sequence number. The header check sequence field 806 ensures proper delivery of the frame. Frames with invalid HCS sequences are discarded. Means are provided to acknowledge the reception of valid frames, and thus allow selected retransmission of those that were received with errored headers. Delivery of packets with error-free headers is assured. For further assurance of delivery, error detection in the tailored 810 can be used.

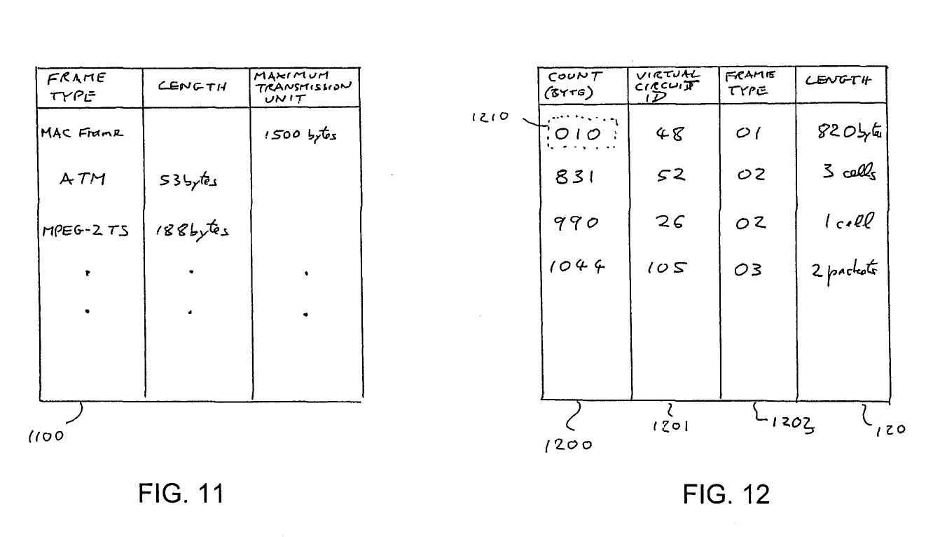

Referring now to FIG. 11, a table of frame types and their respective lengths is shown. The frame type is defined on the downstream broadcast control channel. Some of the frame types are individually known in existing communication systems and three such types are shown in column 1100 in FIG. 11. The illustrated types are MAC frame, ATM cell and MPEG-2 packets. In addition, newly defined formats can be included in the table. The definitions of the various formats of the different types of frame are periodically transmitted on the broadcast control channel and (less frequently) they are transmitted on the downstream data channels. As illustrated in FIG. 11, a MAC frame is variable in length up to a maximum of 1500 bytes, an ATM cell has a length of 53 bytes and a MPEG-2 TS packet has a length of 188 bytes.

When a gateway 20 requires service in terms of requiring an allocation of bandwidth, or when it requires additional bandwidth, or when the bandwidth allocated to that gateway exceeds the gateway's updated requirements, the gateway makes a new request from the wireless router 30, using the request message of FIG. 9 and makes this request based on quality of service (QoS) definitions. The QoS definitions include a number of QoS parameters, such as minimum bandwidth, maximum latency, maximum delay, etc.). The wireless router 30 attempts to allocate a channel to the residential gateway 20 in a manner that will most closely match the requested QoS definitions Whether the wireless router is ever able to exactly match the requested QoS definition depends upon the degree of loading of the system and other factors.

Guaranteed bandwidth, maximum delay and maximum delay variation and frame delay variation are among the parameters that can be specified. Based on the parameters specified in the request message (in session ID field 803) the host is polled by the subscriber gateway on a periodic basis corresponding to a “service contract”.

On the downstream channel, there is a channel allocation map that specifies when subscriber units can and should transmit on the upstream channel. The channel allocation map also defines when bandwidth requests such as illustrated in FIG. 9 and actual data transport frames, such as illustrated in FIG. 8, can and should be transmitted. FIG. 12 illustrates an example of a downstream channel allocation map transmitted by the wireless router 30. In column 1200 there is a byte count. In column 1201 there is a session ID identifier. In column 1203 there is a frame type, and in column 1204 there is a length indicator. In operation, the column 1200 need not be transmitted, because the information contained therein is derivable from the initial bit count 1210 and the information in columns 1203 and 1204. It is merely necessary for the subscriber device to be synchronized to the count of the wireless router, that is to say for the subscriber device to have prior knowledge of the byte count of the wireless router for any given item in a downstream channel allocation map.

To achieve this synchronization, a byte count is sent periodically downstream to the residential gateways. This count is treated with priority in that it is immediately removed from the link and used to update the gateways' local byte count. This byte count along with a fixed delay component is used for the gateway to transmit on the upstream channel. The fixed delay is calculated during registration and corresponds to the relative distance between the gateway and the router base station. Thus the upstream transmissions can be synchronized to the downstream byte counts.

The byte count can be sent in the downstream channel allocation map or as an explicit management type message.

Each session ID in column 1201 is unique for the entire autonomous system, i.e. it uniquely defines the connection between the subscriber gateway or other subscriber device and an edge router in the system. If a subscriber unit roams to another wireless router (e.g. from wireless router 30 to wireless router 32), the same session ID will be used for the connection.

The frame type in column 1203 is already explained and is a type that appears in field 801 of any frame. In the example given, frame type 01 is a MAC frame, frame type 02 is an ATM cell and frame type 03 is an MPEG packet. Other frame types may be indicated, up to a maximum of 16 different frame types. The frame types fall into three categories: different types of network layer frame (e.g. ATM/MPEG/IP); different types of MAC layer operational frames (e.g. request/ack/grant); and one management frame. For the management frame, the frame control field 802 can indicate different types of management messages, e.g. ranging type for synchronization. With 16 possible frame types and four used for MAC layer operational frames and a management frame, there remain 12 frame types that can be used to support up to 12 different network layer frame types (of which 3-4 are described in this text). Column 1204 indicates the length of the particular frame (in the case of variable length frame types) or the number of cells or packets (in the cases of fixed length frame types).

From the information in columns 1201, 1203 and 1204, and from the start byte count 1210, any subscriber device can identify the start byte count of any frame. Thus, for example, the three ATM cells on the virtual circuit ID 52 begin with byte count 831, which is the byte which immediately follows the final byte of the variable frame that has session ID 48 (which starts at byte count 010 and is 820 bytes in length). Note that an ATM cell is 53 bytes in length, so that it is not necessary in column 1204 to indicate the number of bytes in the ATM cell. Each subscriber unit has prior knowledge of the number of bytes in an ATM cell or the number of bytes in an MPEG packet and, with this knowledge and the knowledge of the number of cells or packets in a given frame, the subscriber unit is able to calculate the byte count of column 1200 for the start of the next frame.

A subscriber device receiving the channel allocation map of FIG. 12 monitors the virtual session IDs to look for those that are associated with that subscriber device. Based on the synchronization to a common byte count and the information in the channel allocation map, each subscriber device knows when to transmit on the upstream channel. An upstream node invites subscriber devices wishing to transmit upstream bandwidth to transmit upstream request messages during idle time slots or frame periods. Subscriber devices contend on those requests and are allocated upstream frame slots which are then indicated to the subscriber devices on the downstream channel allocation map.

Frames or cells are passed on to the upstream nodes or the network management module by the wireless router and any intermediate routers.

In this way, the MAC layer is cognizant of the type of network layer above the MAC layer—i.e. the type of network layer packets that it is transporting—by virtue of the network layer frame type indicator in the MAC layer header. This is not typical in the design of network architecture. (Normally, the lower layer protocols are not cognizant of the higher layer ones and as such perform generically for multiple higher layer protocols) This approach describes a lower layer protocol that has knowledge of what is being transported. It can then treat the higher layer protocol data units more effectively based on known requirements and characteristics of that protocol. With this knowledge, the MAC layer is able to appropriately allocate time to different packets and is even able to fragment different packets in a manner suited to the contents of the packets in the MAC layer. For example, it can fragment an MPEG stream on 188 byte boundaries and an ATM stream on 53 byte boundaries and treat these as a single stream handled by the MAC layer.

The basic MAC layout described is scaleable and works on high 25 speed (510 Mbps) as well as low speed or narrow band (about 500 1 Kbps) channels. The wireless router 30 strips the wireless encapsulation header 800 from the protocol data unit 810 and forwards the protocol data units (IP packets, ATM cells, MPEG-2TS packets, etc.) to the appropriate network interface.

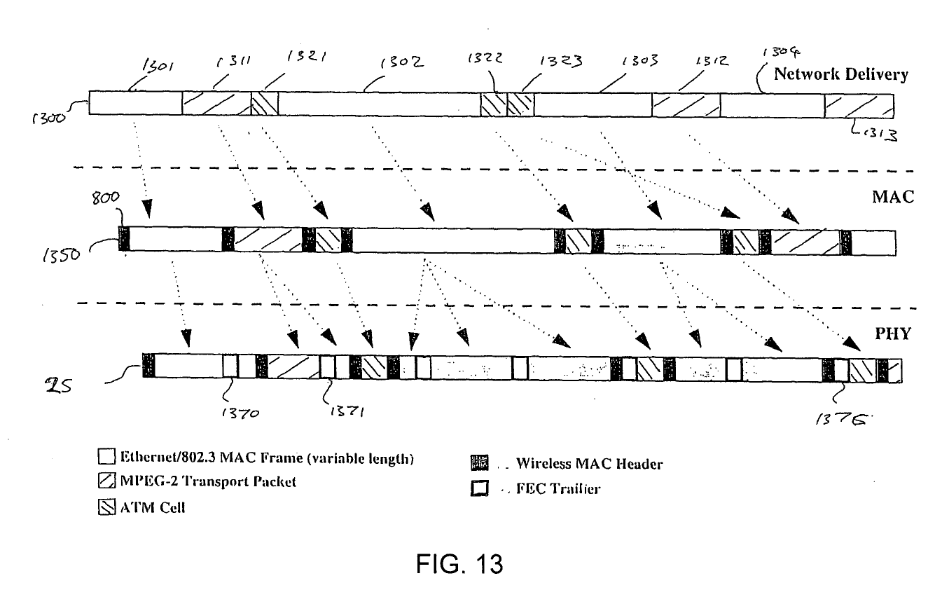

Referring now to FIG. 13, a time diagram illustrating an example of the communication of different frame types as simultaneous multiplex streams on the channel 25 is shown. At the top of the figure is shown a data stream 1300 in the network layer. The data stream comprises Ethernet MAC frames (containing IP packets) 1301, 1302, 1303 and 1304, of variable lengths. It also shows MPEG-2 transport packets 1311, 1312 and 1313, all of fixed lengths. Further, it shows ATM cells 1321, 1322 and 1323, also of fixed length. As an example, the Ethernet MAC frames 1301, 1302 1303 and 1304 may represent a continuous Ethernet session all having the same session ID. Similarly, the MPEG packets 1311, 1312 and 1313 may represent a continuous stream of video having a common session ID and the ATM cells 1321, 1322 and 1323 may represent another continuous stream of data.

Referring to the data stream below the network data steam 1300, there is an MAC layer data stream 1350. In this MAC layer, each of the Ethernet frames 1301, 1302, 1303 and 1304, as well as each of the MPEG packets 1311, 1312 and 1313 and the ATM cells 1321, 1322, 1323 has been passed down to the MAC layer data steam 1350 without any fragmentation—i.e. each PDU layer from the network layer is intact as a consecutive stream of bytes in the MAC layer. Added to each PDU is a wireless MAC header 800, as described and illustrated in FIG. 8. Each header has a frame type in the frame type field 801 that indicates the type of PDU that follows that header. Note that the order of the various PDU's in the network layer data stream 1300 is preserved in the MAC layer data stream 1350, with the exception that the ATM cell 1323 is reversed in position vis-à-vis the Ethernet packet 1303. This reversal of the order is dictated by the adherence to QoS contracts. In this case, the Ethernet frame needs to be transmitted before the ATM cell, to meet delay requirements. Thus, it is typical for an ATM cell to have a higher delay variation than an Ethernet packet and the QoS parameters for the ATM cell. Accordingly, the sending unit (either the subscriber gateway 20 or the wireless router 30) delays the frame having the higher frame delay parameter relative to the frame having the lower frame delay parameter.

From the MAC layer data stream 1350, the various frames are passed to the physical channel 25 as shown, with their various wireless MAC headers and additionally with FEC trailers 1370, 1371, etc. added at regular intervals. The insertion of the FEC trailer takes no account of the frame type or other position at which the FEC trailer is inserted. Fragmentation or segmentation is implemented for stricter QoS realization. Long packets are fragmented, so that packets requiring minimum delay or delay variation can be inserted into the stream. The wireless MAC fragment or segment size is 16 bytes. A specific type is defined for a MAC fragment. For a fragment, the length 804 field refers to multiples of 16 bytes. Bandwidth requests are always in terms of non-fragmented frame types. Bandwidth allocation for transfer of a wireless MAC frame may be in terms of fragments depending on the service that the host device has subscribed from the network. The wireless router makes the decision on this. The network knows the type and length of the buffered information requesting transfer. The wireless router can instruct the residential gateway to fragment upstream packets, fragmenting the information based on negotiated service for that host, as well as the count mix of traffic in the system.

Fragmentation can be implemented to compensate for instantaneous error characteristic of the channel. For example, if the wireless router experiences a high degree of retransmission, it can fragment downstream packets to a higher degree. This has the advantage that greater fragmentation provides smaller packets to retransmit and a higher likelihood of successful receipt, thereby reducing the need for retransmission. Similarly the wireless router can instruct the gateway 20 to fragment to a higher (or lesser) degree. The frequency of retransmission is just one instantaneous error characteristic of the channel that can be measured to determine the required degree of fragmentation. The bit error rate is another measure that can be used. The bit error rate is determined by the wireless router from a cyclical redundancy check (CRC) code or FEC code in the upstream data. Thus the wireless router selectively fragments packets to be sent from the wireless router to the subscriber subsystem gateway 30 to a degree of fragmentation dependent on the instantaneous error characteristic of the channel.

Alternatively, the gateway 20 can independently measure instantaneous error characteristics of the channel and independently decide to increase the degree of fragmentation. The bit error rate is determined by the gateway from a CRC code in the downstream data or from the FEC code in the trailers 1370-1376.

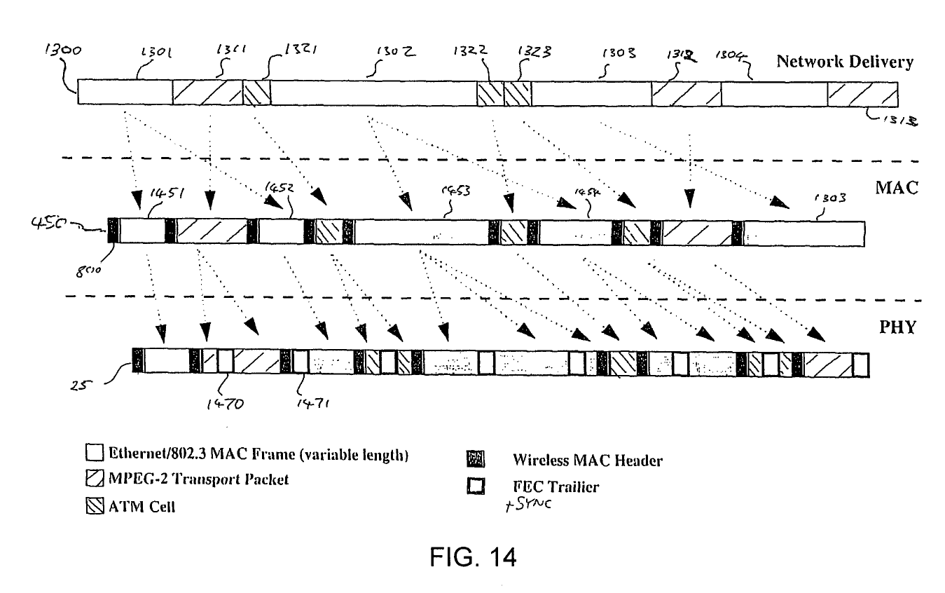

Fragmentation or segmentation is described with reference to FIG. 14, in which an example similar to FTC 13 is illustrated, but in this example there is fragmentation in the MAC layer and interaction with the physical layer. At the top of FTC. 14 there is the same stream of data 1300 as is found at the top of FIG. 13. In the MAC layer data stream 1450, the Ethernet frames 1301 and 1302 have been fragmented into fragments 1451 and 1452, as well as 1453 and 1454, respectively. Ethernet frame 1303 remains intact in the MAC layer.

The reason for the fragmentation is a desire to pass the MPEG-2 transport packets 1311 and 1312 through the system with minimum delay variation. This illustrates an example of QoS parameters for the MPEG-2 transport packets that demand lower time delay variation than the parameters for the corresponding parameters in FIG. 13. Such parameters would be selected where frame jitter for the video would be intolerable, for example in live video. In order to pass the MPEG-2 transport packet 1311 through to the physical layer with minimum delay, Ethernet frame 1301 is fragmented upon the arrival of MPEG-2 packet 1311 and the second fragment 1452 (which would otherwise require a delay of the packet 1311) is delayed until after the MPEG-2 transport packet 1311 has been transferred to the MAC layer. Similarly, Ethernet frame 1302 is fragmented into two parts 1453 and 1454 in order to allow for immediate transfer of ATM cell 1322 to the MAC layer. Such an occurrence would take place when the cell delay variation or the maximum cell delay QoS parameter of the cell stream 1322 demanded a higher quality of service (in terms of delay) than the Ethernet packet 1302. In this example, ATM cell 1323 is not a part of the same session as ATM cell 1322 and has a different session ID in its session TD field 803 and is subject to different QoS parameters. As a result, it is not necessary for ATM cell 1323 to be transferred to the MAC layer immediately, but instead the Ethernet packet fragment 1454 is transferred to the MAC layer and the ATM cell 1323 follows. As for the MPEG packet 1311, the MPEG packet 1312 is transferred to the MAC layer in advance of the Ethernet frame 1303, on account of its more demanding QoS parameters.

Thus, the scheme by which fragmentation is performed in the MAC layer is dependent on: (a) the type of information being delivered to the MAC layer form the network layer; (b) the QoS contract between the wireless router and the gateway and (c) the instantaneous characteristics of the channel. p From the MAC layer, the various frames, fragments, cells and packets are transferred to the physical layer radio channel 25 in the order presented in the MAC layer, together with their MAC headers 800. FEC trailers 1470, 1471, etc. are inserted in the physical layer at regular intervals as already described with reference to FIG. 13.

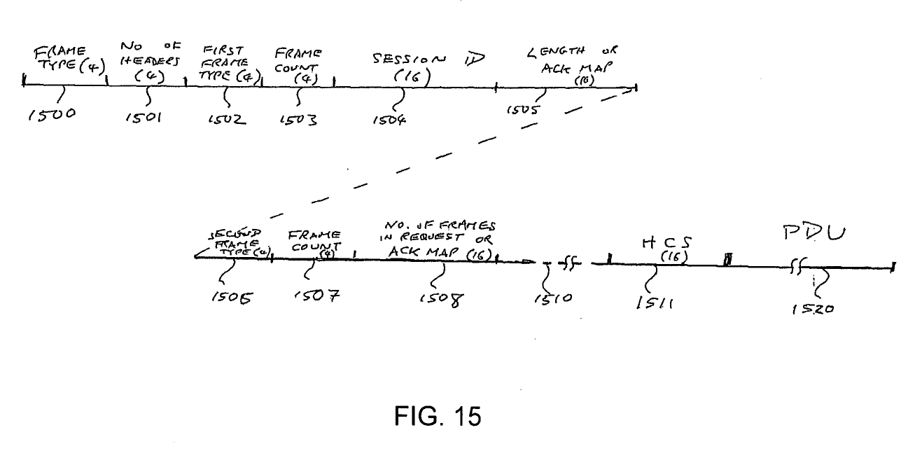

The preferred embodiment of the invention also employs concatenation or piggybacking of frames, This feature enables a terminal (a subscriber gateway or other subscriber device) or a wireless router to piggyback new requests or acknowledgments onto data packets. Preferably only management type header messages are allowed to be piggybacked. Preferably there is only one PDU per concatenated header. An example is shown in FIG. 15.

A frame with a concatenated header is illustrated in FIG. 15, comprising a field type 1500, a number of headers field 1501, a first frame type field 1502, a frame count field 1503, a session ID field 1504 and a length/ACK-map field 1505. Immediately following the length/ACK-map field 1505, in the same continuous frame is a second frame type field 1506, a second frame count field 1507 and a field 1508 which is used selectively or alternatively to indicate the number of frames in a request or to provide an acknowledgment map. Following the field 1508, there may be further frame type fields, frame counts and other concatenated fields 1510. The header concludes with a header check sequence 1511, following which is a PDU 1520.

The frame type field 1500 is 4 bits in length and contains a special frame type indicator indicating that this frame is a concatenated header based frame. The number of headers field 1501 has 4 bits and indicates the number of concatenated headers up to a maximum of 16 possible headers. The first frame type field 1502 has 4 bits and indicates the frame type of the first header. This frame type indicates the nature of the PDU 1520, if such a PDU is present. The frame count field 1503 is 4 bits in length and gives the frame count for the first concatenated frame. The session ID 1504 is the only session ID in the frame. All header information applies to one and only one session ID.

The field 1505 can include a variety of information depending on the first frame type in field 1502. It can include a length indicator indicating the length of the PDU 1520 or an ACK map if the frame is a mere acknowledgment and there is no PDU 1520. Following field 1506 is the second frame type field 1506, indicating the type of the header that is being concatenated with the first frame. In the field 1507 there is a frame count, which is set to one for the second frame, Following frame count 1507 is another field 1508 similar to field 1505, which includes a variety of information such as the number of frames or bytes of a bandwidth request or an acknowledgment map for an ACK frame. Unlike field 1505, field 1508 does not include a length indication indicating the length of the PDU. Following field 1508 there may be further frame type fields, frame counts and further fields similar to field 1508 in the space indicated as 1510. As already stated, there may be up to 16 concatenated frames. Following the last header portion, there is a header check sequence 1511 for checking the integrity of the header. Following the header check sequence is the PDU 1520 (if any) identified in the first frame type 1502.

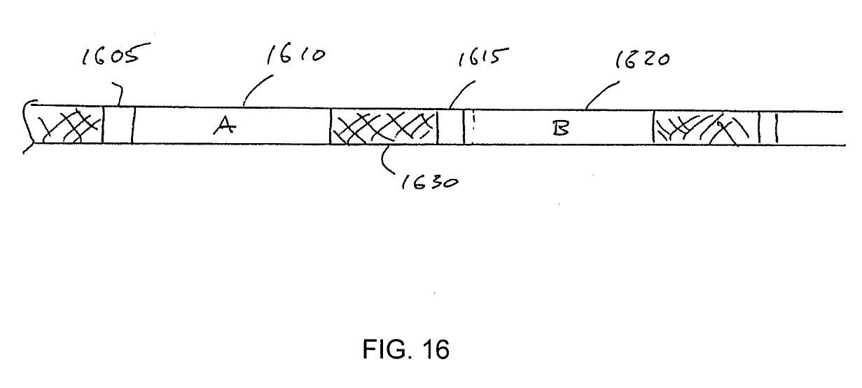

For completeness, FIG. 16 shows packet traffic on an upstream link from two gateways (or a single gateway having two logical channels) and a wireless router. One gateway 20 sends packet 1610 (labeled “A”) preceded by FEC trailer and synchronization 1605 and the other gateway 22 sends packet 1620 (labeled “B”) preceded by FEC trailer and synchronization 1615 There is a guard band 1630 between each packet on the upstream link. The figure is not to scale.

The upstream link can be separated from the downstream link by frequency in a frequency-division-duplex (FDD) system or, more preferably by time in a time-division-duplex (TDD) system. Of course, time and frequency division can be employed.

Time division duplex has the advantage of enabling broader band channels to be employed and allocated to the upstream and the downstream links as required. The channel allocation map of FIG. 12 defines the start time for every upstream transmission and can define the duration of an upstream transmission period. After the upstream transmission period, all gateways switch into receive mode to receive downstream traffic (and to receive a new channel allocation map if desired). During the upstream transmission period there is no synchronization being received from the wireless router and all gateways must maintain clock times with respect to the last synchronization 1376 from the wireless router. The guard bands 1630 permit a degree of drift between system clocks of different gateways (and allow for different propagation times and other discrepancies) and prevent collisions between the trailing end of one packet and the leading end of another.

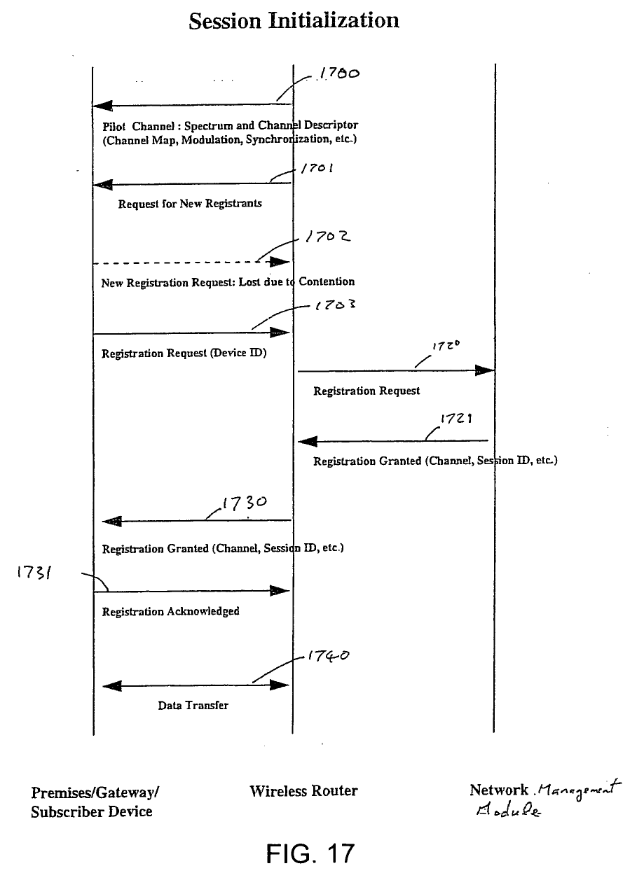

Turning now to FIG. 17, a message flow diagram is shown illustrating exchanges of messages between a residential gateway 20, a wireless router 30 and a network management module 50 during registration and session initialization.

On a periodic basis the wireless router 30 sends out, on the downstream pilot channel 500, a spectrum description map with the channel description, modulation scheme, synchronization scheme description and the like Also on a periodic basis, the wireless router 30 sends out a request or invitation 1.701 for new registrants (new registrations). It is possible that a residential gateway 20 may send out a registration request 1702 in response to the invitation 1.701 but that this request 1702 collides with another request from another gateway 22, in which case both requests will be lost. If this happens, the gateway 20 will not receive any grant message from the wireless router and the gateway 20 will resend the registration request after some backoff time delay measured from the time of receipt of the invitation 1701 (or a later invitation). Eventually (e.g. after a backoff time) a registration request 1703 is received at the wireless router, containing an identification number (ID) for the wireless gateway or other device requesting registration.

In response to receipt of the registration request from the gateway 20, the wireless router 30 sends the registration request (1720) to the network management module 50. The network management module replies with a registration grant message (1721) containing a channel identifier, a session ID and any other necessary or useful information, The channel identifier may identify a predefined segment of the available spectrum by number (this scheme could be used if the available spectrum is separated into a predetermined number of fixed channels) or, more preferably, it defines the upper and lower ends (F_{xL} to F_{xL} as shown in FIG. 5) of the assigned channel. In response to receipt of the registration grant message i721, the wireless router 30 sends a registration grant message 1730 with the same parameters to the gateway 20 (or other device). The gateway 20 responds with a registration acknowledgment message 1731 and a session 1740 begins between the gateway 20 and the wireless router.

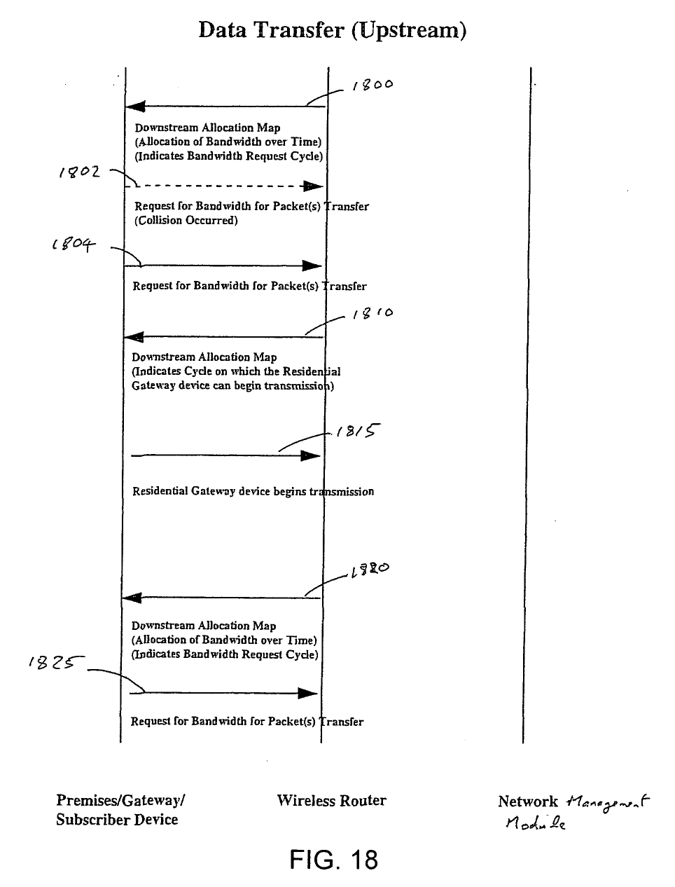

FIG. 18 shows the session 1740 in greater detail, with emphasis on upstream data transfer. Periodically the wireless router 30 sends a downstream channel allocation map 1800 on the allocated downstream channel. FIG. 18 shows two such maps 1800 and 1820 sent by the wireless router of its own accord (or in response to some other event not related to gateway 20) and it shows a downstream channel allocation map 1810 sent in response to a request i804 from the gateway 20.

In a TDD system the downstream channel allocation map defines the bandwidth allocated in terms of time and indicates the bandwidth request cycle. In response to channel allocation map 1800 a gateway can transmit a request for bandwidth for packet transfer 1802. If the gateway does not receive, within a predetermined time-out time, a downstream channel allocation map including an allocation granting the requested bandwidth (or if the next channel allocation map received by the gateway 20 does not include an allocation granting the requested bandwidth), the gateway can assume that the request 1802 was lost (e.g. because it collided with some other request) and the gateway resends the request 1804.

In due course the wireless router receives message 1810 with a downstream channel allocation map granting the request and similarly indicating the cycle on which the gateway 20 can begin transmitting. The gateway begins transmitting with transmission 1815 until completed or until some other event. At some later time (e.g. at a periodic time) the wireless router sends another downstream channel allocation map 1820. The new downstream channel allocation map 1820 may cause the gateway 20 to send another request for bandwidth 1825, for example in the case where the new map reduces the bandwidth allocated in the previous channel allocation map.

During the session 1740, no communication with the network management module 50 is necessary.

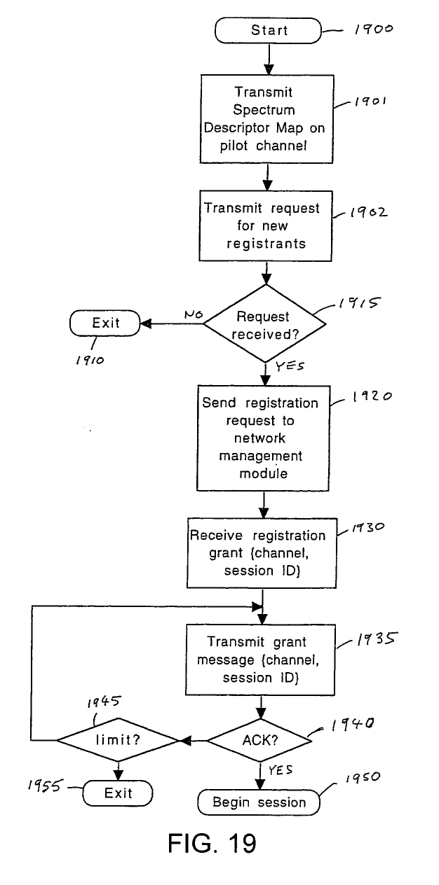

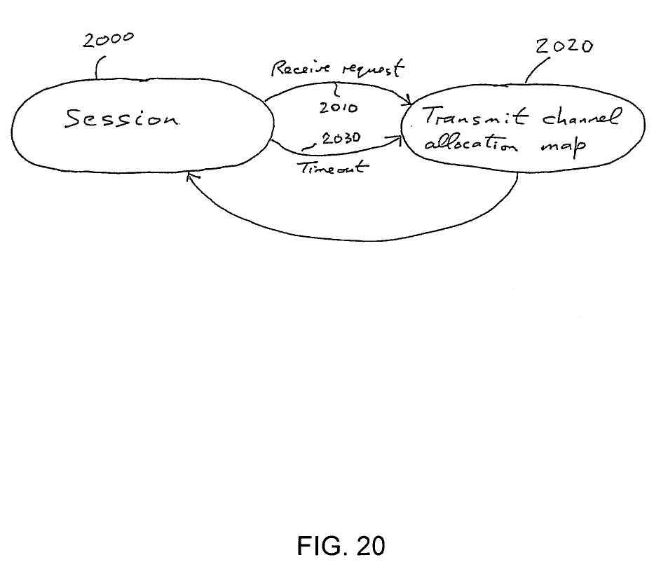

FIG. 19 and 20 illustrate processes performed by a computer program in the controller 421 of the wireless router 30. The processes are implemented by instructions stored in memory in the controller 421.

FIG. 19 is a flow chart illustrating the process performed by the wireless router in the exchange of messages as shown in FIG. 17. The program begins at step 1900 and in step 1901 the wireless router transmits the spectrum descriptor map on the pilot channel. In step 1902, the wireless router transmits a request for new registrants. Following step 1902, the wireless router switches to receive mode and listens for any new registration requests. If no new request is received, the process exits at step 1910. From step 1910, the process simply restarts at step 1900 after an appropriate time-out. It may be noted that steps 1901 and 1902 do not necessarily occur together. For example, there may be repeated transmissions of requests for new registrants between transmissions of spectrum descriptor maps. Alternatively, there may be multiple transmissions of spectrum descriptor maps and only infrequent transmissions of requests for new registrants.

Following the decision of step 1915, if a new request is received from a wireless gateway, the wireless router at step 1920 sends, via link 34, a registration request to the network management module 50. In response, at step 1930, the wireless router 30 receives a registration grant message, which includes at least a channel identifier and a session identifier, The channel identifier can take various forms, as described above. An example is an upper frequency and a lower frequency defining the spectrum bounds for the channel. If the wireless router fails to receive the registration grant in step 1930, various mechanisms can be attempted to receive the registration grant, including a retry mechanism. If the registration grant is not received, the processor must exit, for example with a transmitted message indicating an error to the wireless gateway. Following step 1930, the wireless router transmits at step 1935 a transmission grant message over the broadband wireless link 25 to the wireless gateway 20. The transmission grant message includes the channel identifier and the session identifier. Following step 1935, the wireless router switches to receive mode and awaits receipt of the registration acknowledgment message 1731. If, in step 1940, this message is received, the session begins at step 1950. If the acknowledgment is not received, and if (step 1945) the number of grant messages already transmitted has not reached a limit, the process returns to step 1935 and the grant message is retransmitted. If after a limited number of attempts step 1940 determines that no acknowledgement (ack) is received, the process exits at step 1955, for example, with another error message being transmitted to the wireless gateway.

When the session begins at step 1950, FIG. 20 illustrates that various events can cause a new transmission by the wireless router of a channel allocation map. From a state 2000 in which one or more sessions are ongoing, a request can be received by the wireless router such as request 1804, for bandwidth for packet transfer. This request causes a transition 2010 to a mode 2020 in which a new channel allocation map is transmitted. Similarly, a transition 2030 can take place from session state 2000 to transmit channel allocation map state 2020 upon the occurrence of a time-out. The time-out can be quite short, for example, several minutes, but is at least a 24-hour time-out. After transmission of the channel allocation map, the process returns automatically from state 2020 to state 2000 and the various sessions continue.

A wireless system has been described having a MAC or similar layer capable of supporting a plurality of different frame types and including a MAC layer header having a frame type indicator, whereby multiple frames of differing frame types are communicated contiguously over the radio channel separated by MAC layer headers.

This approach provides a MAC or similar layer protocol, below the network layer, that has knowledge of what is being transported. It enables the MAC or similar layer to treat the higher layer protocol data units more effectively based on known requirements and characteristics of that protocol. Accordingly the MAC layer is cognizant of the properties of the various network layers above it and performs its operation (quality of service scheduling, fragmentation, etc.) based on the type of network layer used to transport the data information.

The above description has been given by way of example only, and modifications of detail can be made by one of ordinary skill in the art without departing from the scope and spirit of the invention.

I claim:

1. A method of operation of a wireless access system having a subscriber subsystem gateway and a wireless router in communication with the subscriber subsystem gateway via a two-way radio channel according to a communication protocol, the method comprising the steps of:
measuring an instantaneous error characteristic of the channel; and
selectively fragmenting packets to be sent from the wireless router to the subscriber subsystem gateway to a degree of fragmentation dependent on the instantaneous error characteristic of the channel.
